(19) United States
(12) Patent Application Publication
(10) Pub. No.: US 2011/0115372 A1
(43) Pub. Date: May 19, 2011

(54) ELECTRIC LAMP WITH PIN CONNECTORS AND METHOD OF MANUFACTURE

(75) Inventors: József Tökés, Erdokertes (HU); István Würsching, Budapest (HU); József Fülöp, Budapest (HU); Ferenc Papp, Budapest (HU)

(73) Assignee: General Electric Company

(21) Appl. No.: 12/620,106

(22) Filed: Nov. 17, 2009

(51) Int. Cl. H01J 61/30; H01J 5/50; H01J 9/24

(52) U.S. Cl. 313/634; 313/318.05; 445/23; 313/116

(57) ABSTRACT

An electric lamp comprises a bulb-shaped outer envelope made of a glass material with a substantially spherical portion for receiving at least a part of at least one light source and an elongated end portion for receiving at least a part of an electronic control gear for energizing the light sources. A base portion attached to the bulb-shaped envelope comprises connecting means for connecting the electronic control gear to an associated power supply. The base portion is provided with a base plate for closing the base portion and the connecting means are pin connectors embedded in the base plate of the base portion. A method of manufacturing a lamp with pin connectors is also disclosed. In this method, an outer envelope made of a glass material is connected to a base portion that has a base plate with embedded pin connectors. A lamp that comprises a bulb-shaped outer envelope made of a plastic material and has a base portion with pin connectors is also provided.

### FIELD OF THE INVENTION

This invention relates to electric lamps with pin connectors, and more particularly to energy saving lamps that can replace incandescent lamps of general purpose. Even more specifically the invention relates to electric lamps that have an outer envelope and a base section with pin connectors.

### BACKGROUND OF THE INVENTION

The so-called energy saving lamps are used in a wide field of industrial and home applications and as a consequence they are replacing more and more the conventional incandescent lamps. Such lamps include the so-called compact fluorescent lamps (CFL), the halogen lamps and the high intensity discharge (HID) lamps. One group of the halogen lamps being used as light sources require a transformer for transforming the line voltage to an appropriate low voltage for the halogen lamp. The compact fluorescent lamps and the high intensity discharge lamps require a special ballast circuit that transforms the line voltage to high frequency ignition voltage. Compact fluorescent lamps with integrated ballast are also referred to as CFLi.

US 2006/0273720 A1 discloses a CFL device with an outer envelope, an integrated ballast circuit and a threaded base for connecting the lamp to a standard Edison type socket. Such a lamp construction however does not enable the exclusive use of a special energy saving lamp that might be a requirement in some buildings. As a consequence of the energy saving program, some countries have issued building regulations requiring the use of dedicated energy saving sockets in new buildings. Lamps with a conventional base can therefore not be used in such buildings.

US 2007/0008728 A1 describes a halogen incandescent lamp with a reflector body and special pin connectors to be connected to a corresponding socket. In this case, the halogen lamp is embedded in a base that seems to be made of a different material (e.g. a plastic material) than the reflector body or shell, which is made of a glass material. The reflector body or shell may be left open at the light exiting side or a light transmitting glass lens may cover it. It is not disclosed how the base and the reflector body are attached to each other.

US 2007/0254512 A1 discloses a light bulb theft-reduction apparatus and method of use comprising the substitution of GU10 two-pin socket connections on otherwise standard, common and publicly available electric lighting lamp fixtures for the purposes of rendering them uncommon for use in publicly accessible facilities such as resorts, hotels and motels. The document further suggests the use of non-removable GU10 adapters or the use of CFL bulbs with GU10 bases. The use of the GU10 CFL bulbs in combination with either the GU10 fixtures or adapters constitutes an economical theft-deterrent for CFL bulbs since they cannot be easily or economically used in a traveler's home.

Accordingly, there is a need for electric lamps for energy saving purposes with a bulbous outer envelope and a base with special connecting elements that may only be used in dedicated sockets instead of the usual threaded or bayonet type sockets. The manufacture of such a base should be well integrated in the manufacturing process of the conventional glass bulb-shaped lamps that may include an energy saving light source and the associated electronic control gear circuit. During manufacturing, it should be guaranteed that the electric components of the electric control gear circuit are not exposed to an elevated heat that could have a negative impact on their subsequent functioning and reliability. It is sought to provide an electric lamp configuration, which readily supports different types of energy saving lamp configurations.

### SUMMARY OF THE INVENTION

In an exemplary embodiment of the present invention, there is provided an electric lamp, which has a longitudinal axis and comprises a bulb-shaped outer envelope made of a glass material with a substantially spherical portion for receiving at least a part of a light source and an elongated end portion for receiving at least a part of an electronic control gear for energizing the light source. A base portion attached to the bulb-shaped envelope comprises connecting means for connecting the electronic control gear to an external associated power supply. The base portion has a base plate for forming a substantially closed end thereof. The base portion is made of a material compatible with the material of the outer envelope and the connecting means are pin connectors embedded in the base plate.

In an exemplary embodiment of another aspect of the present invention, a method for manufacturing an electric lamp is proposed. The method comprises the following steps:
providing an outer envelope of a glass material comprising a substantially spherical portion and an elongated end portion being terminated by an open end on a base side;
providing a base portion with connecting means for connecting an electronic control gear to an external associated power supply, in which
the base portion is made of a material compatible with the material of the outer envelope and the connecting means are pin connectors embedded in a base plate of the base portion and further comprising the step of
connecting the base portion to the outer envelope.

In an exemplary embodiment of still further aspect of the present invention, an electric lamp, which has a longitudinal axis and comprises a bulb-shaped outer envelope made of a plastic material, is provided. The outer envelope has a substantially spherical portion for receiving at least a part of at least one light source and an elongated end portion for receiving at least a part of a control gear for energizing the light source. The base portion comprises connecting means for connecting the electronic control gear to an associated power supply. The base portion has a base plate for forming a substantially closed end thereof. The connecting means are pin connectors embedded in the base plate.

The disclosed electric lamp provides for a selective connectibility to a special socket designed for energy saving lamps (ESL). Such a special socket may be for example a GU10 or GZ10 type or any other socket different from the conventional bayonet (BC) or Edison (E26 or the like) type sockets used for incandescent lamps or current CFLi-s. By using a base configuration with pin connectors instead of a conventional bayonet (BC) or Edison (E26 or the like) type base, it can be prevented that lamps other than energy saving lamps may be used in the special or dedicated sockets. A further positive effect achieved by the invention is an effective protection of the electronic control gear circuit against heat applied during sealing of the different glass parts of the lamp by connecting the base portion to the outer envelope in a production step preceding the introduction of the electronic control gear circuit into the outer envelope. Most of the consecutive manufacturing steps used during the production of a conventional incandescent lamp may be maintained, thereby better conditions are provided for mass production. The use of a glass or a compatible material of the base section provides a possibility to make benefit of the production line used for manufacturing conventional incandescent lamps, which also reduces the cost of production especially when compared with other GLS (General Lighting Service) look alike lamps. The proposed lamps provide a certain level of protection against environmental load due to the outer envelope, which can be made of a glass material or a plastic material. A plastic outer envelope has a greater resistance to mechanical and thermal stresses.

### BRIEF DESCRIPTION OF THE DRAWINGS

The invention will now be described in more detail with reference to the enclosed drawing, in which

FIG. 1 illustrates the method steps of providing a glass tube and cutting off a section of the tube,

FIG. 2 illustrates the method step of heating a circumferential section of the tube,

FIG. 3 illustrates the method steps of forming a base portion and combining the pin connectors with a base plate,

FIG. 4 illustrates the method step of forming an intermediate connecting portion,

FIG. 5 illustrates the method step of connecting the outer envelope with the base portion with a diameter different from the diameter of the lamp,

FIG. 6 is a side view of the lamp with an outer envelope and a base portion having different diameters,

FIG. 7 illustrates the method step of connecting the outer envelope with the base portion of substantially the same diameter,

FIG. 8 is a side view of a lamp with an outer envelope and a base portion having the same diameter,

FIG. 9 is a side view of the lamp of FIG. 6 with a halogen lamp as a light source,

FIG. 10 is a side view of the lamp of FIG. 6 with a CFL as a light source,

FIG. 11 is a side view of the lamp of FIG. 8 with a HID lamp as a light source and

FIG. 12 is a side view of the lamp of FIG. 8 with a LED as a light source,

FIG. 13 is a side view of the lamp of FIG. 8 with a light source that is a combination of a compact fluorescent lamp and a halogen lamp,

FIG. 14 is a side view of a lamp with an outer envelope made of a plastic material.

### DETAILED DESCRIPTION OF THE INVENTION

Referring first to FIGS. 6 and 8, two different embodiments of an electric lamp according to an aspect of the invention are shown. The lamps shown in FIGS. 6 and 8 comprise a bulb-shaped outer envelope 30 being made of a glass material with a substantially spherical portion 31 for receiving at least a part of a light source and an elongated end portion 32 for receiving at least a part an electronic control gear for energizing the light source. A base portion 33 comprises connecting means for connecting the electronic control gear to an external associated power supply. The base portion, which is provided with a base plate 19 for closing the base portion 33, is made of a material compatible with the material of the outer envelope 30 and the connecting means are pin connectors 11, 12 embedded in the base plate of the base portion.

The electric lamp has a longitudinal axis 37 and the pin connectors are arranged substantially parallel to the longitudinal axis of the lamp and spaced apart from each other in order to fit into an associated pin socket. The base and socket pair may be of the type GU10 or any other socket different from the conventional bayonet (BC) or Edison (E26 or the like) type sockets used for incandescent lamps or current CFLi-s.

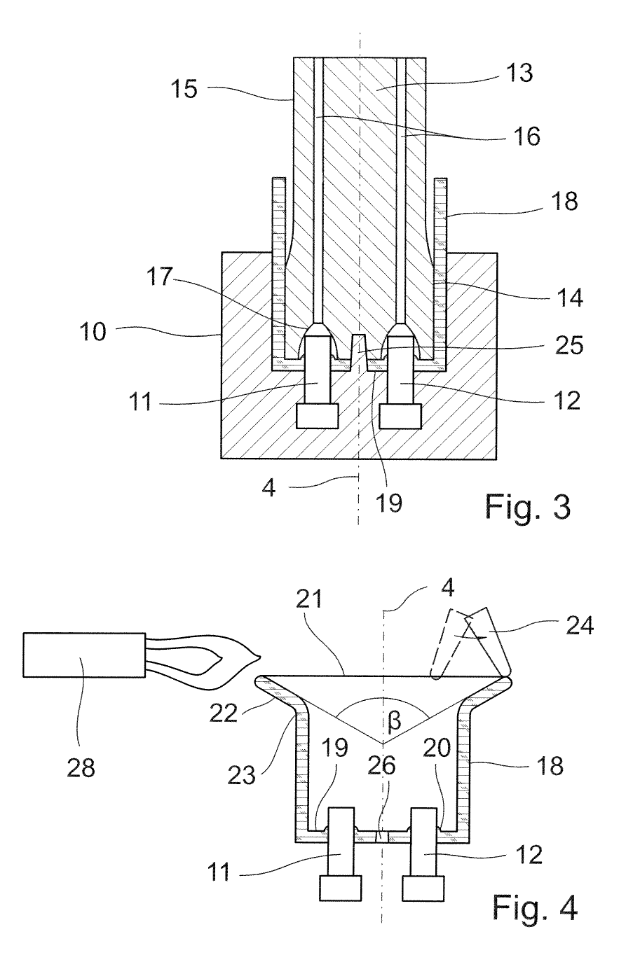

The base portion of the electric lamp as it can be best seen on FIGS. 3 and 4, has a cylindrical portion 18, which is connected to the base plate 19. The base plate of the base portion may be further provided with at least one ventilation hole 26. The ventilation holes of the shown embodiment are positioned between the pin connectors but other arrangements are also possible. The ventilation holes provide for air circulation between the inside of the lamp comprising heat producing elements, such as the light source and the electronic control gear circuit and the environment, which is normally colder than the atmosphere inside the lamp during operation.

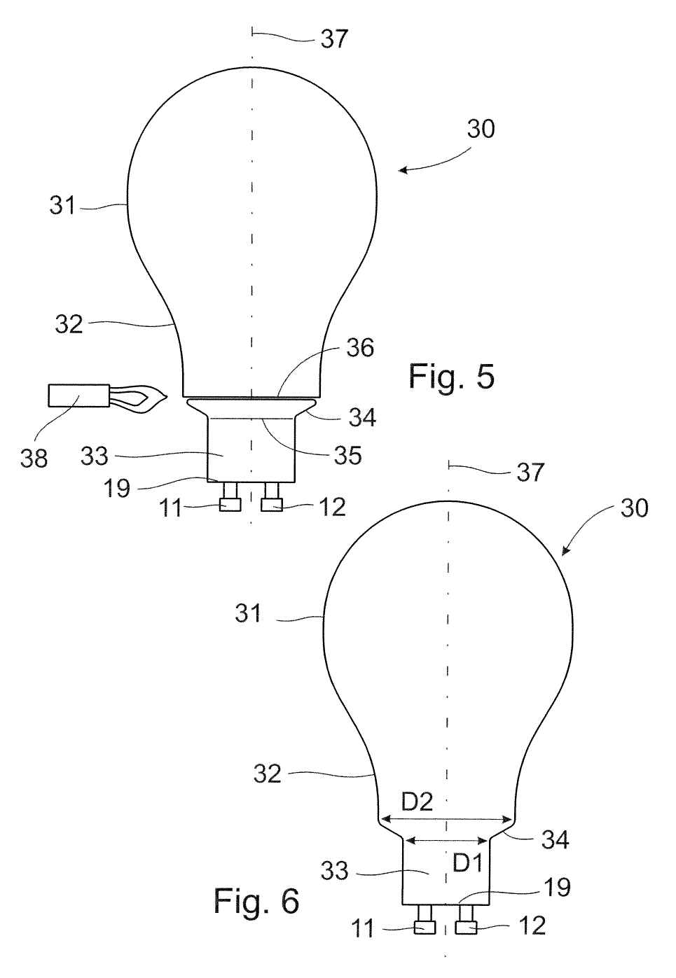

In the embodiment shown in FIGS. 5 and 6, the elongated end portion 32 of the outer envelope and the cylindrical portion 33 of the base portion have an open end 36, 35 of a substantially circular form with different diameter. The open end 35 of the base portion is connected to the open end 36 of the outer envelope 30 indirectly through an intermediate connecting portion 34. The intermediate connecting portion 34 is formed integrally with the base portion 33 and has a substantially conical form with a first diameter D1 corresponding to the diameter of the cylindrical portion and a second diameter D2 corresponding to the diameter of the open end 36 of the outer envelope. The cone angle β of the conical intermediate connecting portion is preferably in the range of 90° and 176°. The wall thickness of the intermediate connecting portion is preferably in the range of 1.0-1.2 mm. The cylindrical portion may have a wall thickness of 1.5 to 1.6 mm and the wall thickness of the base plate may be greater than 2 mm. The diameter of the ventilation hole may be in the range of 0.5-0.6 mm.

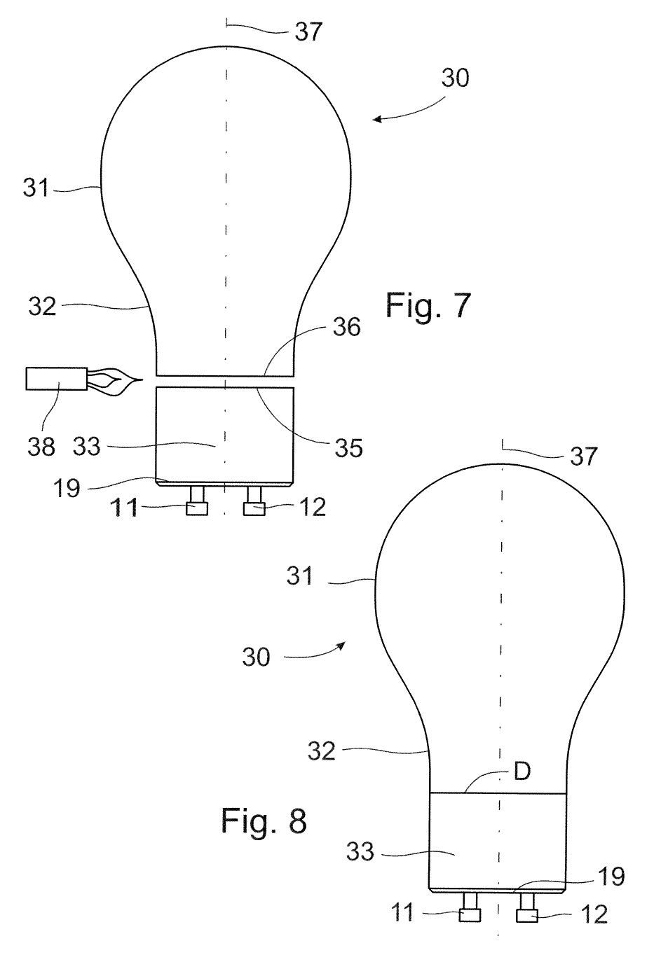

In the embodiment shown in FIGS. 7 and 8, the elongated end portion 32 of the outer envelope and the cylindrical portion 33 of the base portion have an open end 36, 35 of a substantially circular form with substantially the same diameter D. The open end 35 of the base portion is connected to the open end 36 of the outer envelope 30 in this case directly, therefore the intermediate connecting portion 34 of FIGS. 5 and 6 may be omitted.

If the base portion is made of a glass material or another material compatible with the glass material of the outer envelope, the base portion may be connected to the outer envelope by sealing. The term “compatible” within the meaning of this specification relates to all materials that have substantially the same thermal expansion coefficient as the glass material of the outer envelope and that can be sealed to the outer envelope e.g. different glass compositions. This requirement applies also to the base portion if it is made of a glass material.

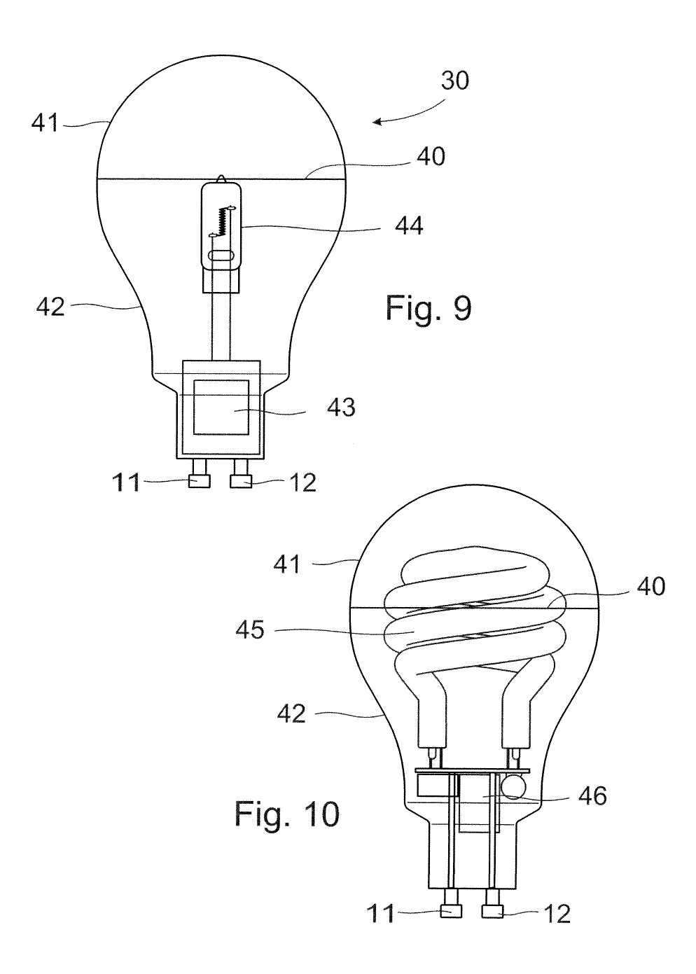

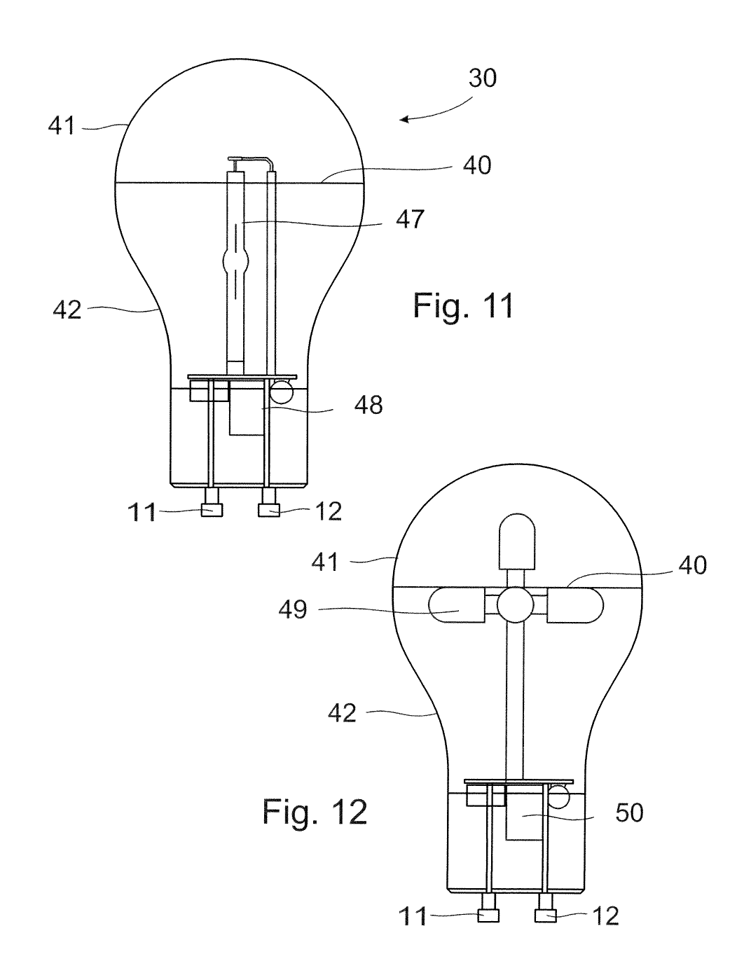

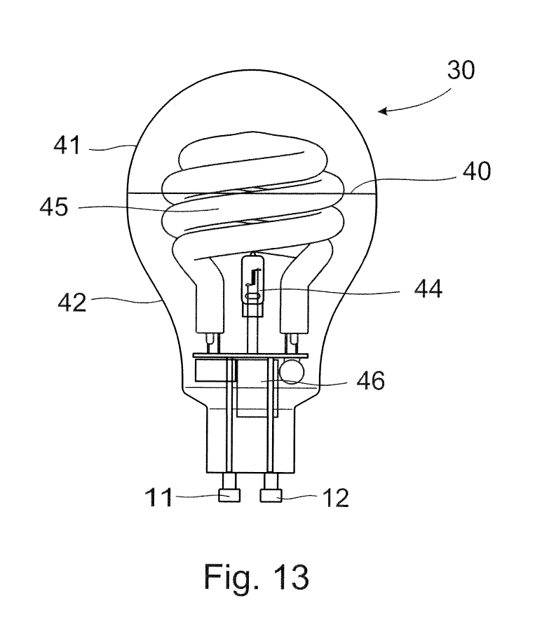

FIG. 9 shows an embodiment in which the light source is a low voltage halogen light source 44 and the electronic gear comprises a transformer 43. In the embodiment shown in FIG. 10, the light source is a low-pressure discharge lamp 45 (CFLi) and the electronic gear comprises a suitable ballast circuit 46. In order to insert the relatively large size discharge tube of the CFLi, it is necessary to cut the outer envelope 30 into two parts 41, 42 and rejoin these parts after assembly as it will be explained in more detail later. FIG. 11 depicts a further embodiment in which the light source is a high-pressure discharge lamp 47 (HID) and the electronic control gear comprises a suitable ballast circuit 48. According to a further aspect of the invention, as shown in FIG. 12, the light source comprises at least one light emitting diode 49 (LED) and the electronic gear comprises a suitable low-voltage power source 50. FIG. 13 illustrates a further embodiment in which the light source is comprised of a combination of a low voltage 44 halogen light source and a low-pressure discharge lamp 45 (CFLi). The electronic control gear comprises a suitable 46 ballast circuit in combination with a transformer. In the event that the light source is a halogen lamp of mains voltage, the electronic control gear may simply be formed of two lead wires that connect the pin connectors to the lamp.

As another aspect of the invention, a method for the production of an electric lamp is proposed. This method comprises the steps of:
providing an outer envelope of a glass material comprising a substantially spherical portion and an elongated end portion being terminated by an open end on a base side;
providing a base portion with connecting means for connecting an electronic control gear to an external associated power supply, in which
the base portion is made of a material compatible with the material of the outer envelope and the connecting means are pin connectors embedded in a base plate of the base portion, and further comprising the step of
connecting the base portion to the outer envelope.

If the base portion is made of a glass material or another material compatible with the glass material of the outer envelope, the base portion 33 may be connected to the outer envelope 30 by sealing (FIGS. 5 and 7).

If the geometrical dimensions of the outer envelope and the base portion are such that a cylindrical portion of the base portion and the elongated end portion of the outer envelope, which have a substantially circular form, have substantially the same diameter, the open end of the base portion may be connected to the open end of the outer envelope directly, e.g. without any further connecting means, as shown in FIG. 7. If however, the elongated end portion of the outer envelope and the cylindrical portion of the base portion have an open end of a substantially circular form with different diameter, the open end of the base portion may be connected to the open end of the outer envelope indirectly through an intermediate connecting portion, as shown in FIG. 5. The intermediate connecting portion may be formed integrally with the base portion and may a substantially conical form with a first diameter D1 corresponding to the diameter of the cylindrical portion and a second diameter D2 corresponding to the diameter of the open end of the outer envelope. It is however also possible to use a separately formed intermediate connecting portion which may be connected or sealed both to the cylindrical portion of the base portion and the elongated end portion of the outer envelope.

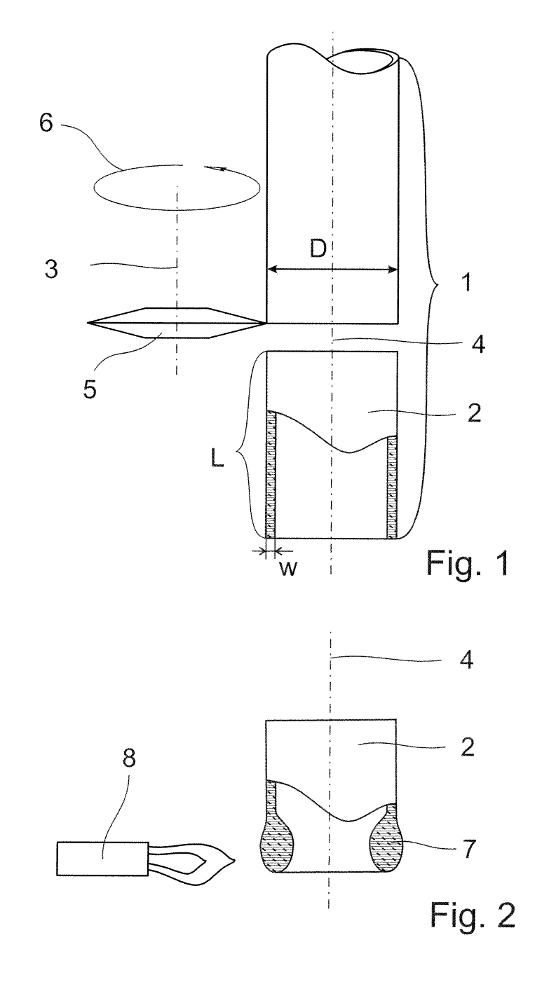

Referring now to FIGS. 1 to 4, the method steps of providing a base portion will be described in more detail. In step one, as depicted in FIG. 1, a tube 1 of a material compatible with the material of the outer envelope is provided with a desired geometry (diameter D, wall thickness w), and thermal expansion coefficient. In order to form the base section, a section 2 of the tube 1 with a predetermined length L has to be cut off for providing sufficient material for the base section. This cutting is performed with a cutting dye 5 that is rotated around an axis 3 of rotation as shown by arrow 6. The tube has to be rotated as well.

In a consecutive step, as shown in FIG. 2, a circumferential section 7 of the tube section is heated at least to the softening point of the tube material, which may be a glass material. In the embodiment shown in FIG. 2, a gas heater 8 applying the heat evenly along the rim section heats the lower circumferential section or rim section of the tube section. The uniform distribution of the applied heat may be achieved by rotating the tube section 2 around an axis 4 of rotation relative to the gas heater 8 or by rotating the gas heater 8 around an axis 4 of rotation relative to the tube section 2. When reaching the softening point of the tube material, the tube material starts to flow and takes a drop like form in cross section as it can be seen in FIG. 2.

In a next step, as shown in FIG. 3, the base portion is formed with a cylindrical portion 18 and a base plate 19 for holding the pin connectors 11 and 12. The base plate 19 is formed of the molten part of the tube section 2. To this end, the softened tube section 2 shown in FIG. 2 is placed into a mold dye comprising a mold form 10 and a mold stamp 13. The mold stamp is moved coaxially into the mold form in order to form the base portion with the cylindrical portion 18 and the base plate 19. After the base portion is formed, the stamp is moved out of the mold form and the base portion with the pin connectors 11 and 12 is removed from the mold form. The pin connectors 11 and 12 are previously received and held in a predetermined position in the mold form 10. When moving the stamp in a downward direction, the soft tube material flows around the pin connectors 11 and 12 thereby embedding them in the base plate 19 at predetermined locations. A plunger 25 or a plurality of plungers, that may be part of the mold form, simultaneously forms at least one ventilation hole 26 (FIG. 4) in the base plate. The stamp 13 has a wider head portion 14, a narrower stem portion 15 and ventilation holes 16 located coaxially with the pin connectors 11 and 12. The ventilation holes 16 have a wider lower region 17 for receiving the stem of the pin connectors and for leaving free space for the tube material in excess. The excess tube material flows into the cavity formed by the wider lower region 17 of the ventilation holes 16 around the pin connectors 11, 12, and it increases thereby the mechanical fixing strength of the base plate. The mold form is preferably a two-part form with a separation plane comprising the pin connectors. Due to such a configuration of the mold form, it is easy to place the pin connectors into the mold form and to remove the ready formed base section from the mold form. In order to keep the tube material in a softened state, the mold form and the stamp are heated to or kept at the softening temperature of the tube material.

The ready formed base portion may be connected or sealed to the open end of the elongated end portion of the outer envelope directly, e.g. without any further connecting means, as it can be seen in FIG. 7. If however, the elongated end portion of the outer envelope has diameter D2 which is greater than the diameter D1 of the cylindrical portion of the base portion, the open end of the base portion may be connected or sealed to the open end of the outer envelope indirectly through an intermediate connecting portion, as shown in FIG. 5. The intermediate connecting portion may be formed integrally with the base portion and may have a substantially conical form with a first diameter D1 corresponding to the diameter of the cylindrical portion and a second diameter D2 corresponding to the diameter of the open end of the outer envelope as shown in FIGS. 4 and 6. During an additional step, the intermediate connecting portion 22 may be formed from the upper part of the cylindrical portion 18 of the base portion. After removal of the stamp the upper circumferential section or rim section 21 of the cylindrical portion 18 is heated by a gas heater 28 and a forming tool 24 is turned from an inside position (dashed line) to an outside position (continuous line) to form the conical connecting portion 22. During forming the intermediate connecting portion 22, the base assembly is rotated around an axis 4 of rotation relative to the gas heater 28 or the gas heater and the forming tool 24 are rotated around the axis 4 of rotation relative to the base assembly. Instead of the mold form 10, other fixing means for holding and rotating the base portion may be used as well. The base portion with such an intermediate connecting portion 22 may be connected to an outer envelope with an elongated end portion if the diameter D2 of the open end of the elongated end portion is greater than the diameter D1 of the cylindrical portion of the base portion, as mentioned before in connection with FIGS. 5-6.

In consecutive manufacturing steps, the outer envelope 30 is cut in two parts 41, 42 along a circular cutting line 40 in a plane substantially perpendicular to the longitudinal axis of the envelope in the middle section of the spherical portion. The details of the two-part outer envelope are described in co-pending U.S. patent application Ser. No. 11/228,136 filed on Sep. 16, 2005, which is hereby incorporated in its entirety by reference. The upper part 41 is removed and the light source with the associated electronic control gear assembly is introduced into and fixed to the lower part 42 and the electronic control gear assembly is electrically connected to the pin connectors 11, 12. In a last step, the upper part 41 of the outer envelope 30 is rejoined and sealed with the lower part 42 in order to obtain a lamp as shown in FIGS. 9 to 12. The position of the circumferential separation line 40 of the outer envelope may be selected in the widest region of the spherical portion of the outer envelope where the wall has a substantially cylindrical form at a relatively large distance from the electronic control gear circuit sufficient to protect the circuit cornponents from the heat of the heater used for sealing the upper part and the lower part of the outer envelope. The light source of the lamp may for example be but not exclusively a halogen lamp (FIG. 9), a compact fluorescent lamp (FIG. 10), a high intensity discharge (HID) lamp (FIG. 11), a light emitting diode (LED) array (FIG. 12) or a combination of a compact fluorescent lamp and a halogen lamp (FIG. 13).

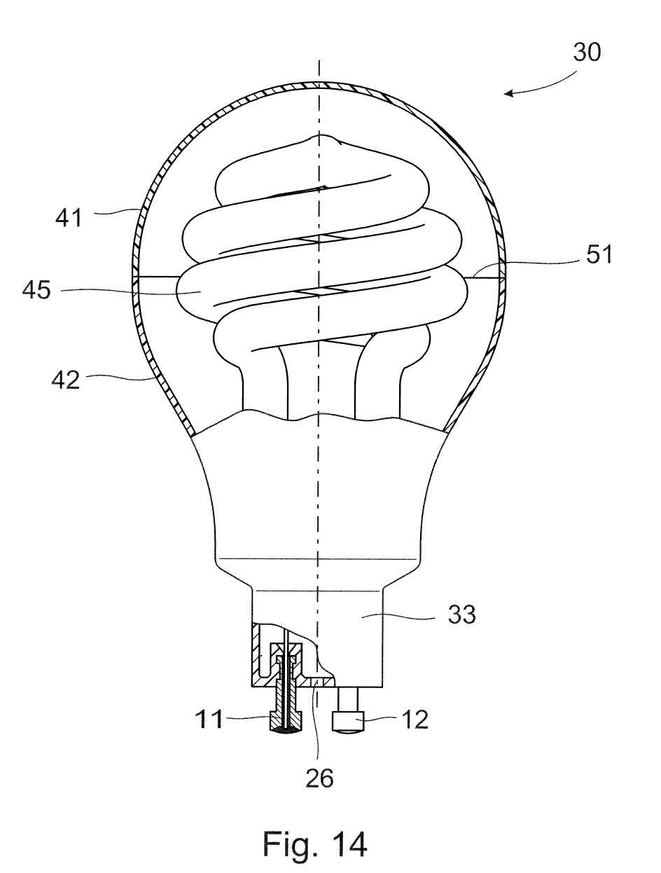

FIG. 14 depicts a further exemplary embodiment of the present invention with an outer envelope 30 of a plastic material, which may be useful in applications where the lamp is exposed to mechanical and thermal stresses. Such an envelope may be prepared of a translucent plastic material, e.g. polycarbonate or a light diffusive plastic material, e.g. polycarbonate-based resin with a coloring additive, such as Lexan 143 of color code 8208, which is manufactured by Saudi Basic Industries Corporation. In this exemplary embodiment, the base portion 33 may be of a glass material, a ceramic material or a plastic material identical with or different from the plastic material of the outer envelope. In each case, the base portion holds embedded pin connectors 11 and 12, which are separated from each other by a predetermined distance. It is also preferable if at least one ventilation hole 26 is made in the base plate of the base portion. In the event that the base portion is made of a material different from the material of the outer envelope, an adhesive connection may be established between the base portion 33 and the plastic material of the outer envelope 30. For example, a silicone adhesive may be used for establishing the adhesive connection. In the case of a base portion made of the same or a compatible material with the plastic material of the outer envelope, the base portion 33 and the outer envelope 30 may be attached to each other by either gluing with an adhesive agent, such as a silicone adhesive, or plastic welding using an appropriate laser or an ultrasonic apparatus.

When the base portion is also made of a plastic material, it is preferable if the base portion 33 and a lower part 42 of the outer envelope, which is adjacent to the base portion, form a one-piece component. This component comprises the pin connectors 11, 12, and may be manufactured by injection molding. The light source with the electronic control gear is introduced into and fixed to the one-piece component, i.e. the interior of the lower part of the outer envelope with the base portion. The electronic control gear is then electrically connected to the pin connectors 11, 12. Subsequently, the lower part 42 of the outer envelope may be closed and connected to the upper part 41 of the envelope along a circumferential line 51, and the upper part and the lower part form a substantially bulb-shaped outer envelope 30. The two plastic parts may be attached to each other by either gluing with an adhesive agent, such as a silicone adhesive, or plastic welding using an appropriate laser or ultrasonic apparatus.

The invention has been disclosed with reference to the drawing, however it might be apparent to those skilled in the art that it is not limited to the shown and disclosed embodiments, but other elements, improvements and variations are also within the scope of the invention. For example, it is clear that the outer envelope may have different forms and the light source may be different from the shown and listed examples or different types of light sources may be combined with each other.

1. An electric lamp having a longitudinal axis and comprising
a bulb-shaped outer envelope being made of a glass material with a substantially spherical portion for receiving at least a part of at least one light source and an elongated end portion for receiving at least a part of an electronic control gear for energizing the light source, and
a base portion comprising connecting means for connecting the electronic control gear to an associated power supply, and
the base portion having a base plate for forming a substantially closed end thereof,
the base portion being made of a material compatible with the material of the outer envelope, and
the connecting means being pin connectors embedded in the base plate.

2. The electric lamp of claim 1, in which the pin connectors are arranged substantially parallel to the longitudinal axis of the lamp and spaced apart from each other in order to fit into an associated pin socket.

3. The electric lamp of claim 1, in which the base plate of the base portion is further provided with at least one ventilation hole.

4. The electric lamp of claim 1, in which the base portion has a substantially cylindrical portion, which is connected to the base plate.

5. The electric lamp of claim 4, in which the elongated end portion of the outer envelope and the cylindrical portion of the base portion have an open end of a substantially circular form with substantially the same diameter; and the open end of the base portion is connected to the open end of the outer envelope directly.

6. The electric lamp of claim 4, in which the elongated end portion of the outer envelope and the cylindrical portion of the base portion have an open end of a substantially circular form with different diameters; and the open end of the base portion is connected to the open end of the outer envelope indirectly through an intermediate connecting portion.

7. The electric lamp of claim 6, in which the intermediate connecting portion is formed integrally with the base portion and has a substantially conical form with a first diameter corresponding to the diameter of the cylindrical portion and a second diameter corresponding to the diameter of the open end of the outer envelope.

8. The electric lamp of claim 7, in which the cone angle of the intermediate connecting portion is in the range of 90° and 176°.

9. The electric lamp of claim 1, in which the base portion is made of a glass material and is connected to the outer envelope by sealing.

10. The electric lamp of claim 1, in which the light source is a halogen light source.

11. The electric lamp of claim 1, in which the light source is a low-pressure discharge lamp (CFLi).

12. The electric lamp of claim 1, in which the light source is a high-pressure discharge lamp (HID).

13. The electric lamp of claim 1, in which the light source comprises at least one light emitting diode.

14. The electric lamp of claim 1, in which the light source comprises a combination of different light sources.

15. A method for manufacturing an electric lamp comprising the steps of:
providing an outer envelope of a glass material comprising a substantially spherical portion and an elongated end portion being terminated by an open end;
providing a base portion with connecting means for connecting an electronic control gear to an external associated power supply,
the base portion having a base plate for forming a substantially closed end thereof, the base portion being made of a material compatible with the material of the outer envelope, and the connecting means being pin connectors embedded in the base plate, and further comprising the step of
connecting the base portion to the outer envelope by sealing.

16. The method of claim 15, in which the base portion has a substantially cylindrical portion and the elongated end portion of the outer envelope and the cylindrical portion of the base portion have an open end of a substantially circular form with substantially the same diameter; and the open end of the base portion is sealed to the open end of the outer envelope directly.

17. The method of claim 15, in which the base portion has a cylindrical portion and the elongated end portion of the outer envelope and the cylindrical portion of the base portion have an open end of a substantially circular form with different diameters; and the open end of the base portion is connected to the open end of the outer envelope indirectly through an intermediate connecting portion.

18. The method of claim 17, in which the intermediate connecting portion is formed integrally with the base portion and has a substantially conical form with a first diameter corresponding to the diameter of the cylindrical portion and a second diameter corresponding to the diameter of the open end of the outer envelope.

19. The method of claim 15, in which the step of providing a base portion further comprises the steps of:
providing a tube of suitable material compatible with the material of the outer envelope, with a desired geometry, and
cutting off a section of the tube with a predetermined length for providing sufficient material for a base section,
heating a circumferential section of the tube section at least to the softening point,
forming the base plate of the molten part of the tube section, and
embedding the pin connectors in the base plate at predetermined locations.

20. The method of claim 19, in which the step of forming the base plate further comprises the step of forming at least one ventilation hole in the base plate.

21. The method of claim 19, in which the step of forming the base plate is carried out by a mold dye comprising a mold form and a stamp.

22. The method of claim 21, in which the pin connectors are received and positioned by the mold form, which is a two-part form with a separation plane comprising the pin connectors.

23. The method of claim 20, in which the step of forming at least one ventilation hole in the base plate is carried out by a mold dye comprising at least one plunger in a mold form.

24. The method of claim 15, in which the base portion is made of a glass material and is connected to the outer envelope by sealing.

25. An electric lamp having a longitudinal axis and comprising
a bulb-shaped outer envelope being made of a plastic material with a substantially spherical portion for receiving at least a part of at least one light source and an elongated end portion for receiving at least a part of an electronic control gear for energizing the light source, and
a base portion comprising connecting means for connecting the electronic control gear to an associated power supply,
the base portion having a base plate for forming a substantially closed end thereof, and
the connecting means being pin connectors embedded in the base plate.

26. The electric lamp of claim 25, in which the outer envelope is made of a translucent plastic material.

27. The electric lamp of claim 25, in which the outer envelope is made of a light diffusive plastic material.

28. The electric lamp of claim 25, in which the base portion is also made of a plastic material and is connected to the outer envelope adhesively.

29. The electric lamp of claim 25, in which the base portion is also made of a plastic material and is connected to the outer envelope by plastic welding.

30. The electric lamp of claim 25, in which the bulb shaped outer envelope is a two part envelope consisting of an upper part and a lower part adjacent to the base portion, and the lower part of the outer envelope and the base portion are made of one part, which is connected to the upper part of the outer envelope.
